(19) United States
(12) Patent Application Publication
(10) Pub. No.: US 2023/0035215 A1
(43) Pub. Date: Feb. 2, 2023

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventors: Yu NAGATA, Tokyo (JP); Toshihiro NAKAMURA, Shizuoka-ken (JP)

(73) Assignee: TOYOTA JIDOSHA KABUSHIKI KAISHA, Toyota-shi (JP)

(21) Appl. No.: 17/838,634

(22) Filed: Jun. 13, 2022

(30) Foreign Application Priority Data
Aug. 2, 2021 (JP) 2021-126766

(51) Int. Cl. G06Q 10/04; G06Q 10/06; G06Q 30/02; G06Q 50/30; G08G 1/0968; G08G 1/0967; G08G 1/00; G05D 1/02

(52) U.S. Cl. CPC G06Q 10/047; G06Q 10/06315; G06Q 30/0207; G06Q 50/30; G08G 1/096811; G08G 1/096725; G08G 1/202; G05D 1/0287; G05D 2201/0212; G05D 2201/0213

(57) ABSTRACT

Provided is a control unit that executes generation of an operation command for a plurality of vehicles of different categories, including a vehicle that can travel with an electric motor, based on information on a predetermined area that is an area where only the vehicle that can travel with an electric motor is allowed to pass through.

### CROSS-REFERENCE TO RELATED APPLICATION

This application claims priority to Japanese Patent Application No. 2021-126766 filed on Aug. 2, 2021, incorporated herein by reference in its entirety.

### BACKGROUND

### 1. Technical Field

The present disclosure relates to an information processing device and an information processing method.

### 2. Description of Related Art

A technique for determining an operation schedule of an autonomous driving vehicle based on schedule information of a plurality of users and attribute information indicating a mutual relationship of at least a part of the users is known (see, for example, WO 2018/230646).

### SUMMARY

An object of the present disclosure is to more appropriately dispatch vehicles when an area with a restriction on the vehicle category that can travel is included.

An aspect of the present disclosure is an information processing device including a control unit that executes generation of an operation command for a plurality of vehicles of different categories, including a vehicle that is able to travel with an electric motor, based on information on a predetermined area that is an area where only the vehicle that is able to travel with the electric motor is allowed to pass through.

An aspect of the present disclosure is an information processing method in which a computer executes: receiving information on a predetermined area that is an area where only a vehicle that is able to travel with an electric motor is allowed to pass through; and generating an operation command for a plurality of vehicles of different categories, including the vehicle that is able to travel with the electric motor, based on the information on the predetermined area.

Another aspect of the present disclosure is a program for causing a computer to execute a process in the above information processing device, or a storage medium that non-temporarily stores the program.

According to the present disclosure, it is possible to more appropriately dispatch vehicles when an area with a restriction on the vehicle category that can travel is included.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a system according to an embodiment;

FIG. 2 is a block diagram schematically showing an example of respective configurations of a vehicle, a server, and a user terminal configuring a system according to the embodiment;

FIG. 3 is a diagram showing an example of a functional configuration of the server;

FIG. 4 is a diagram illustrating a relationship between a first route and a predetermined area;

FIG. 5 is a diagram showing an example of a table configuration of user information stored in a user information database (DB);

FIG. 6 is a diagram showing an example of a table configuration of vehicle information stored in a vehicle information DB;

FIG. 7 is a diagram showing an example of a functional configuration of the user terminal;

FIG. 8 is a diagram showing a functional configuration of an electronic control unit (ECU);

FIG. 9 is a flowchart of a vehicle dispatch process according to a first embodiment;

FIG. 10 is a flowchart showing a flow of a process for generating a combination of a route and a vehicle executed in step S105 of FIG. 9;

FIG. 11 is a diagram illustrating a detour route;

FIG. 12 is a flowchart showing a flow of a process for generating a combination of a route and a vehicle executed in step S105 of FIG. 9;

FIG. 13 is a diagram showing an example of a functional configuration of a server according to a third embodiment;

FIG. 14 is a diagram showing an example of a table configuration of electric energy consumption information stored in an electric energy consumption information DB; and

FIG. 15 is a flowchart of a charge plan generation process according to the third embodiment.

### DETAILED DESCRIPTION OF EMBODIMENTS

An information processing device that is one of the modes of the present disclosure includes a control unit. The control unit executes generation of an operation command for a plurality of vehicles of different categories, including a vehicle that can travel with an electric motor, based on information on a predetermined area that is an area where only a vehicle that can travel with an electric motor is allowed to pass through.

The vehicle may move autonomously or may be moved by being driven by a driver. The vehicle includes, for example, a battery electric vehicle (BEV), a plug-in hybrid electric vehicle (PHEV), a hybrid electric vehicle (HEV), a fuel cell electric vehicle (FCEV), a vehicle capable of traveling only with an internal combustion engine (an internal combustion engine vehicle), and the like. These vehicles are examples of vehicles of different categories. Further, the BEV, the PHEV, the HEV, and the FCEV are examples of vehicles that can travel with an electric motor. An internal combustion engine vehicle is an example of a vehicle that cannot travel with an electric motor. It should be noted that the PHEV and the HEV that travel with an internal combustion engine as a drive source due to low remaining charge of the battery can be considered to be an example of a vehicle that cannot travel with an electric motor.

Here, for example, an area in which the drive source of the vehicle is restricted may be set in order to solve an environmental problem. For example, it is conceivable that a vehicle using an internal combustion engine that emits exhaust gas as a drive source is prohibited from entering urban areas. Further, for example, in order to protect the environment, it is conceivable that a vehicle using an internal combustion engine as a drive source is prohibited from entering mountainous areas. In this way, the area where there is a restriction on the category of the vehicle that can pass through and where only a vehicle that can travel with an electric motor is allowed to pass through is defined as a predetermined area. The predetermined area may be a geofence area. The BEV, the PHEV, and the HEV can pass through the predetermined area, but at that time, the drive source must be set to the electric motor to travel.

The information on the predetermined area includes, for example, map information indicating the predetermined area. Further, the control unit generates operation commands for a plurality of vehicles based on the information on the predetermined area. The operation command includes, for example, information on the route of each vehicle. For example, the control unit generates a combination of a route and a vehicle so that only vehicles that can pass through the predetermined area are combined with routes passing through the predetermined area, and generates an operation command so that each vehicle travels according to this combination.

Hereinafter, embodiments of the present disclosure will be described with reference to the drawings. The configurations of the following embodiments are illustrative, and the present disclosure is not limited to the configurations of the embodiments. Further, the following embodiments can be combined as much as possible.

### First Embodiment

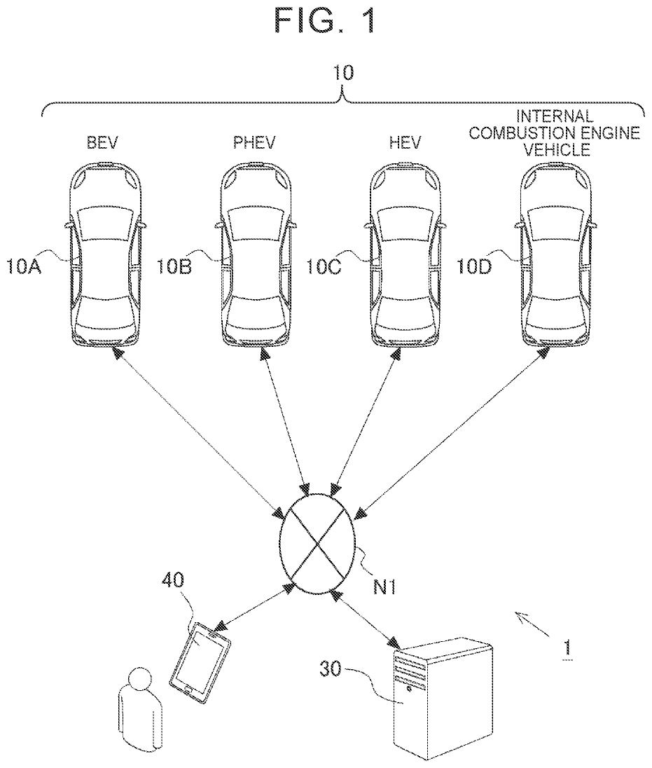

FIG. 1 is a diagram showing a schematic configuration of a system 1 according to a first embodiment. The system 1 includes one or more vehicles 10, a server 30, and one or more user terminals 40. The vehicle 10 includes, for example, a BEV 10A, a PHEV 10B, an HEV 10C, and an internal combustion engine vehicle 10D. The BEV 10A is a vehicle including only an electric motor described below as a drive source. The PHEV 10B is a hybrid electric vehicle capable of charging a battery from a commercial power source, and is a vehicle including an electric motor and a later-described internal combustion engine as drive sources. The HEV 10C is a hybrid electric vehicle incapable of charging a battery from a commercial power source, and is a vehicle including an electric motor and an internal combustion engine as drive sources. Each of the BEV 10A, the PHEV 10B, and the HEV 10C can also charge the battery by regeneration during deceleration. The internal combustion engine vehicle 10D is a vehicle including only an internal combustion engine as a drive source.

Although four categories of vehicles 10 are shown in FIG. 1 as an example, other categories of vehicles (for example, an FCEV) may be included. Also, it is not necessary to include all categories of the vehicles 10 shown in FIG. 1. Further, in FIG. 1, one vehicle 10 of each category is shown, but multiple vehicles 10 of each category may be used. Hereinafter, when the category of the vehicle 10 is not distinguished, it is simply referred to as the vehicle 10. The vehicle 10 may be a vehicle capable of autonomous traveling or a vehicle capable of traveling manually by a driver. Further, the vehicle 10 may be a vehicle used for rideshare or a vehicle used for a taxi. The vehicle 10 may be a plurality of vehicles owned by one business operator. Hereinafter, the vehicle 10 will be described as a vehicle capable of autonomous traveling.

The user terminal 40 is, for example, a terminal owned by a user who uses rideshare or a taxi. The user sends, to the server 30, a request to use the rideshare or the taxi by using the user terminal 40. When the server 30 receives, from the user, the request to use the rideshare or the taxi, the server 30 selects a vehicle 10 and generates a route.

The vehicle 10, the server 30, and the user terminal 40 are connected to each other by a network N1. The network N1 is, for example, a world-wide public communication network such as the Internet, and a wide area network (WAN) or other communication networks may be adopted. In addition, the network N1 may include a telephone communication network such as a mobile phone network or a wireless communication network such as Wi-Fi (registered trademark).

The system 1 according to the first embodiment is a system that, when the vehicle is dispatched in an area including the predetermined area permitted only for traveling with the electric motor, preferentially assigns the vehicle 10 capable of traveling with the electric motor to the route passing through the predetermined area. For example, the BEV 10A that can travel only with an electric motor is preferentially assigned to a route passing through the predetermined area. Further, for example, the PHEV 10B or the HEV 10C that can travel with an electric motor is assigned to a route passing through the predetermined area, and the drive source is restricted so that the route is traveled with the electric motor within the predetermined area. The route passing through the predetermined area is a route in which at least a part of the route passes through the predetermined area.

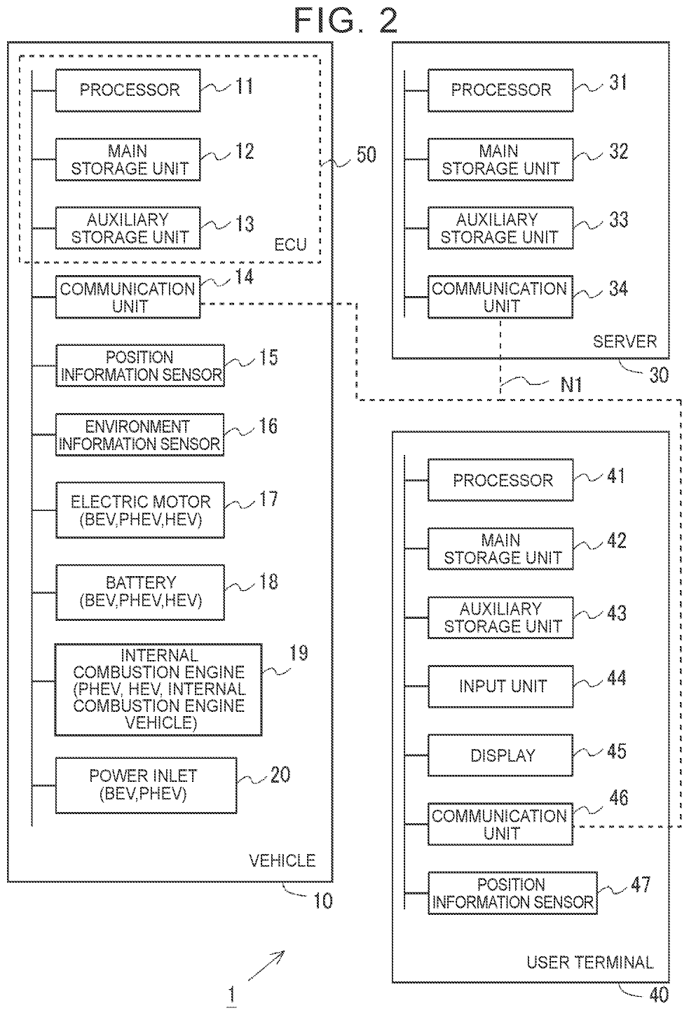

Hereinafter, detailed hardware configurations of the vehicle 10, the server 30, and the user terminal 40 will be described with reference to FIG. 2. FIG. 2 is a block diagram schematically showing an example of respective configurations of the vehicle 10, the server 30, and the user terminal 40 configuring the system 1 according to the present embodiment.

The vehicle 10 includes an ECU 50, a communication unit 14, a position information sensor 15, an environment information sensor 16, an electric motor 17, a battery 18, an internal combustion engine 19, and a power inlet 20. Hereinafter, it is assumed that the vehicle 10 is a vehicle capable of autonomous traveling.

The ECU 50 has a computer configuration. The ECU 50 drives each control component to control the vehicle 10 based on an output signal, etc. input from various sensors. The ECU 50 includes a processor 11, a main storage unit 12, and an auxiliary storage unit 13. The components are connected to each other by a bus.

The processor 11 is a central processing unit (CPU), a digital signal processor (DSP), or the like. The processor 11 controls the vehicle 10 and performs various information processing calculations. The main storage unit 12 is a random access memory (RAM), a read-only memory (ROM), or the like. The auxiliary storage unit 13 is an erasable programmable ROM (EPROM), a hard disk drive (HDD), a removable medium, or the like. The auxiliary storage unit 13 stores an operating system (OS), various kinds of programs, various kinds of tables, and the like. The processor 11 loads the program stored in the auxiliary storage unit 13 into the work area of the main storage unit 12 and executes the program. Through the execution of the program, each component is controlled. As a result, the ECU 50 realizes the function that matches the predetermined purpose. The main storage unit 12 and the auxiliary storage unit 13 are computer-readable recording media. The information stored in the auxiliary storage unit 13 may be stored in the main storage unit 12. Further, the information stored in the main storage unit 12 may be stored in the auxiliary storage unit 13.

The communication unit 14 is means for communicating with the server 30 via the network N1. The communication unit 14 is a circuit for communicating with other devices (for example, the server 30) via the network N1 using wireless communication network such as a mobile communication service (for example, a telephone communication network such as the fifth generation (5G), the fourth generation (4G), the third generation (3G), and long term evolution (LTE)), Wi-Fi (registered trademark), Bluetooth (registered trademark), and the like.

The position information sensor 15 acquires position information (for example, latitude and longitude) of the vehicle 10 at a predetermined cycle. The position information sensor 15 is, for example, a global positioning system (GPS) receiving unit, a wireless communication unit, or the like. The information acquired by the position information sensor 15 is recorded in, for example, the auxiliary storage unit 13 or the like and transmitted to the server 30.

The environment information sensor 16 is means for sensing the state of the vehicle 10 or sensing the periphery of the vehicle 10. Examples of the sensor for sensing the state of the vehicle 10 include a gyroscope sensor, an acceleration sensor, or an azimuth sensor. Examples of the sensor for sensing the periphery of the vehicle 10 include a stereo camera, a laser scanner, a light detection and ranging (LIDAR) sensor, a radar, or the like.

The electric motor 17 is, for example, a three-phase alternating current synchronous motor generator. The electric motor 17 has a function as an electric motor that drives the vehicle 10 by receiving electric power supplied from the battery 18. The electric motor 17 can assist the output of the internal combustion engine 19 as needed. Further, the electric motor 17 can generate electric power by using the energy generated from the internal combustion engine 19, or can generate electric power by regeneration when the vehicle 10 is decelerated. As a result, the battery 18 can be charged. As another method, in addition to the electric motor 17 that drives the vehicle 10, a generator that generates electric power by regeneration may be separately provided. The electric motor 17 is mounted on each of the BEV 10A, the PHEV 10B, and the HEV 10C, and is not mounted on the internal combustion engine vehicle 10D.

The battery 18 is a secondary battery that can be charged and discharged, such as a nickel-cadmium storage battery, a nickel-hydrogen storage battery, or a lithium ion battery. The battery 18 is electrically connected to the electric motor 17 via an inverter or the like such that the charging electric power of the battery 18 is supplied to the electric motor 17 to be able to drive the electric motor 17 for power running and the generated electric power of the electric motor 17 can be charged to the battery 18. Therefore, the battery 18 is mounted on each of the BEV 10A, the PHEV 10B, and the HEV 10C, and is not mounted on the internal combustion engine vehicle 10D. However, the internal combustion engine vehicle 10D is equipped with, for example, a small battery for operating a starter or the like. The storage capacity of the battery 18 is the largest for the BEV 10A, and decreases in the order of the PHEV 10B and the HEV 10C.

The internal combustion engine 19 combusts fuel in a cylinder to generate power for rotating an output shaft connected to a crankshaft. Each cylinder of the internal combustion engine 19 is provided with a fuel injection valve for injecting the fuel. The fuel injection valve is connected to the ECU 50 via an electric wire, and the opening/closing timing of the fuel injection valve is controlled by the ECU 50. The fuel is, for example, gasoline or light oil. The internal combustion engine 19 is mounted on each of the PHEV 10B, the HEV 10C, and the internal combustion engine vehicle 10D, and is not mounted on the BEV 10A.

The power inlet 20 is a unit for receiving electric power supplied from the outside of the vehicle 10. The battery 18 is charged by this electric power. The power inlet 20 is mounted on each of the BEV 10A and the PHEV 10B, and is not mounted on the HEV 10C and the internal combustion engine vehicle 10D.

Next, the hardware configuration of the server 30 will be described. The server 30 has a computer configuration. The server 30 includes a processor 31, a main storage unit 32, an auxiliary storage unit 33, and a communication unit 34. The components are connected to each other by a bus. The processor 31, the main storage unit 32, and the auxiliary storage unit 33 are similar to the processor 11, the main storage unit 12, and the auxiliary storage unit 13 of the vehicle 10, respectively, and thus the description thereof will be omitted. The processor 31 is an example of the control unit. The main storage unit 32 or the auxiliary storage unit 33 is an example of the storage unit.

The communication unit 34 is a means for communicating with the vehicle 10 and the user terminal 40 via the network N1. The communication unit 34 is, for example, a local area network (LAN) interface board or a wireless communication circuit for wireless communication. The LAN interface board or the wireless communication circuit is connected to the network N1.

Next, the user terminal 40 will be described. The user terminal 40 is a small computer such as a smartphone, a mobile phone, a tablet terminal, a personal information terminal, a wearable computer (smart watch, for example), or a personal computer (PC). The user terminal 40 includes a processor 41, a main storage unit 42, an auxiliary storage unit 43, an input unit 44, a display 45, a communication unit 46, and a position information sensor 47. The components are connected to each other by a bus. The processor 41, the main storage unit 42, the auxiliary storage unit 43, the communication unit 46, and the position information sensor 47 are similar to the processor 11, the main storage unit 12, the auxiliary storage unit 13, the communication unit 14, and the position information sensor 15 of the vehicle 10, respectively, and thus the description thereof will be omitted. The information acquired by the position information sensor 47 is recorded in, for example, the auxiliary storage unit 43 or the like and transmitted to the server 30.

The input unit 44 is means for receiving an input operation performed by the user, and is, for example, a touch panel, a mouse, a keyboard, a push button, or the like. The display 45 is means for presenting information to the user, for example, a liquid crystal display (LCD), an electroluminescence (EL) panel, or the like. The input unit 44 and the display 45 may be configured as one touch panel display.

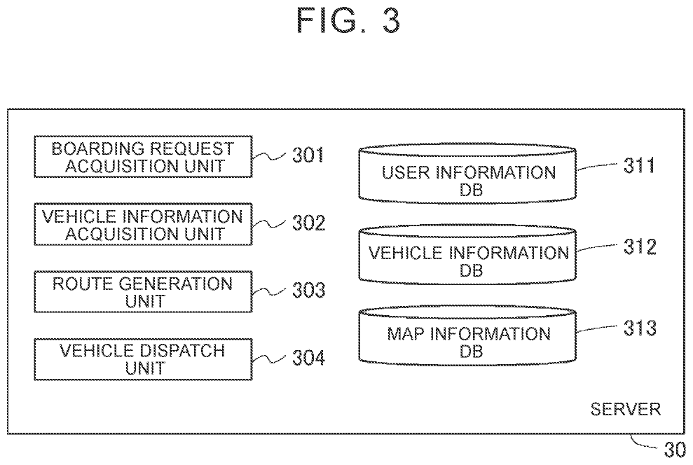

Next, the function of the server 30 will be described. FIG. 3 is a diagram showing an example of a functional configuration of the server 30. The server 30 includes, as functional components, a boarding request acquisition unit 301, a vehicle information acquisition unit 302, a route generation unit 303, a vehicle dispatch unit 304, a user information DB 311, a vehicle information DB 312, and a map information DB 313. The processor 31 of the server 30 executes the processes of the boarding request acquisition unit 301, the vehicle information acquisition unit 302, the route generation unit 303, and the vehicle dispatch unit 304 by a computer program on the main storage unit 32. However, any of the functional components or part of the processes thereof may be executed by a hardware circuit.

The user information DB 311, the vehicle information DB 312, and the map information DB 313 are established when the program of a database management system (DBMS) executed by the processor 31 manages the data stored in the auxiliary storage unit 33. The user information DB 311, the vehicle information DB 312, and the map information DB 313 are, for example, relational databases.

Note that any of the functional components of the server 30 or part of the processes thereof may be executed by another computer connected to the network N1.

The boarding request acquisition unit 301 acquires a boarding request from the user terminal 40 of a user who wishes to move using the vehicle 10, for example. The boarding request is information including an identifier (user identification (ID)) of the user and information for the user to request the use of the vehicle 10. The boarding request is generated in the user terminal 40. The boarding request includes information on a user ID, a departure location, a destination, a usage time, and the like (the information is also referred to as user information below). The departure location may be a current location detected by the user terminal 40. When the boarding request acquisition unit 301 acquires the boarding request, the user information included in the boarding request is stored in the user information DB 311 described below.

The vehicle information acquisition unit 302 acquires information on the vehicle 10. Hereinafter, the information on the vehicle 10 is also referred to as vehicle information. The vehicle information includes, for example, information on a current location, a destination, a vehicle category, and a route of the vehicle 10. The current location of the vehicle 10 is acquired based on position information transmitted from the vehicle 10. The destination and the route of the vehicle 10 are generated by the server 30 in response to the boarding request. The vehicle category is information indicating a category such as the HEV, the PHEV, the BEV, and the internal combustion engine vehicle, and is input by, for example, an administrator of the server 30. The vehicle information acquisition unit 302 stores the vehicle information in the vehicle information DB 312 described below.

The route generation unit 303 generates a route of the vehicle 10. The route generation unit 303 generates a route such that, for example, the vehicle 10 departs from a base and returns to the base via the departure location and the destination of the user. Instead of the base of the vehicle 10, the current location of the vehicle 10 may be used as the departure location of the vehicle 10. The route is generated based on map information stored in the map information DB 313 described below. The route is generated so as to be a route pursuant to a predetermined rule, such as a route with the shortest moving distance of the vehicle 10 or a route with the shortest moving time of the vehicle 10. A well-known technique can be used to generate the route.

Then, the vehicle dispatch unit 304 combines the route generated by the route generation unit 303 and the vehicle 10. The vehicle dispatch unit 304 extracts a route passing through the predetermined area from the routes generated by the route generation unit 303. This route is called a first route. There can be multiple first routes. The first route is a route in which at least a part thereof passes through the predetermined area, and the entire route may pass through the predetermined area.

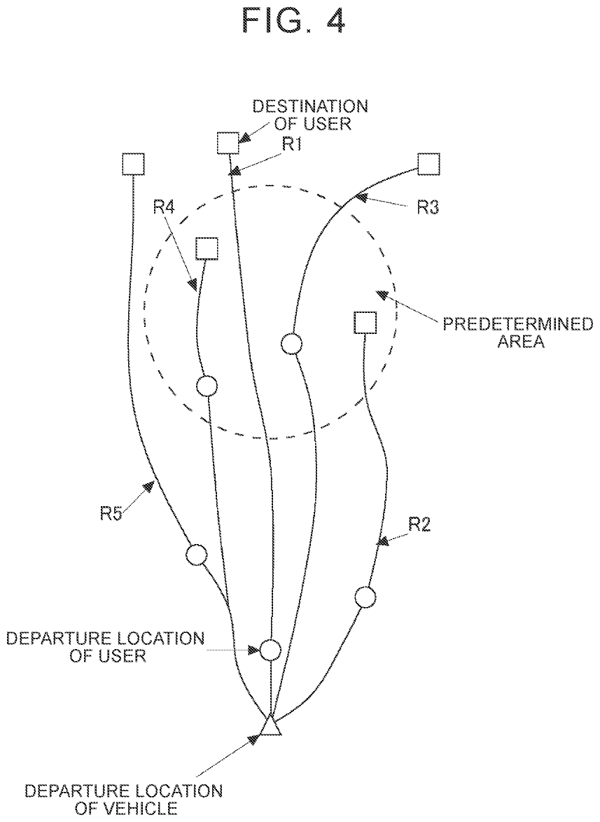

FIG. 4 is a diagram illustrating a relationship between the first route and the predetermined area. In FIG. 4, the boundary line defining the inside and outside of the predetermined area is shown by a broken line. The inner area surrounded by the broken line is the predetermined area. R1 to R5 indicate the routes of the vehicle 10. The departure location (for example, base) of the vehicle 10 at one end of each route is indicated by a triangle, the departure location of the user is indicated by a circle, and the destination of the user at the other end of each route is indicated by a square. After arriving at the destination of the user, the vehicle 10 shall return to the departure location of the vehicle 10 through the same route as the outbound route.

R1 is a route in which the departure location of the user and the destination of the user are outside the predetermined area, but is a route that passes through the predetermined area on the way. R2 is a route that passes through the predetermined area because the destination of the user is within the predetermined area, although the departure location of the user is outside the predetermined area. R3 is a route that passes through the predetermined area because the departure location of the user is within the predetermined area, although the destination of the user is outside the predetermined area. R4 is a route that passes through the predetermined area because the departure location of the user and the destination of the user are within the predetermined area. R5 is a route in which the departure location of the user and the destination of the user are outside the predetermined area, and is a route that does not pass through the predetermined area on the way. Therefore, R1 to R4 are first routes that pass through the predetermined area, and R5 is a route that does not pass through the predetermined area.

For the first route, the vehicle dispatch unit 304 combines the vehicle 10 with the electric motor 17 as a drive source, that is, any vehicle 10 of the BEV 10A, the PHEV 10B, and the HEV 10C. At this time, the priority of the BEV 10A may be the highest, and the priority may be lowered in the order of the PHEV 10B and the HEV 10C. This is because the capacity of the battery 18 of the BEV 10A is the largest, and the capacity of the battery 18 decreases in the order of the PHEV 10B and the HEV 10C. For example, the BEV 10A may be combined with the first route in order, and after the first routes for the number of the BEVs 10A are determined, the PHEV 10B may be combined with the first route. Subsequently, when the first routes for the number of the PHEVs 10B are determined, the HEV 10C may be combined with the first route.

As another method, the vehicle dispatch unit 304 may combine the BEV 10A with the first route in the order from the first route having the longest distance, and after the first routes for the number of the BEVs 10A are determined, the PHEV 10B may be combined with the first route. Subsequently, when the first routes for the number of the PHEVs 10B are determined, the HEV 10C may be combined with the first route.

On the other hand, for the route that does not pass through the predetermined area, the internal combustion engine vehicle 10D may be preferentially combined, or any vehicle 10 from the BEV 10A, the PHEV 10B, the HEV 10C, and the internal combustion engine vehicle 10D may be combined.

When the vehicle dispatch unit 304 determines the combination of the route and the vehicle 10, the vehicle dispatch unit 304 generates an operation command including the route generated by the route generation unit 303 and transmits the operation command to each vehicle 10. The operation command includes a command to travel on the route generated by the route generation unit 303 according to the usage time of the user.

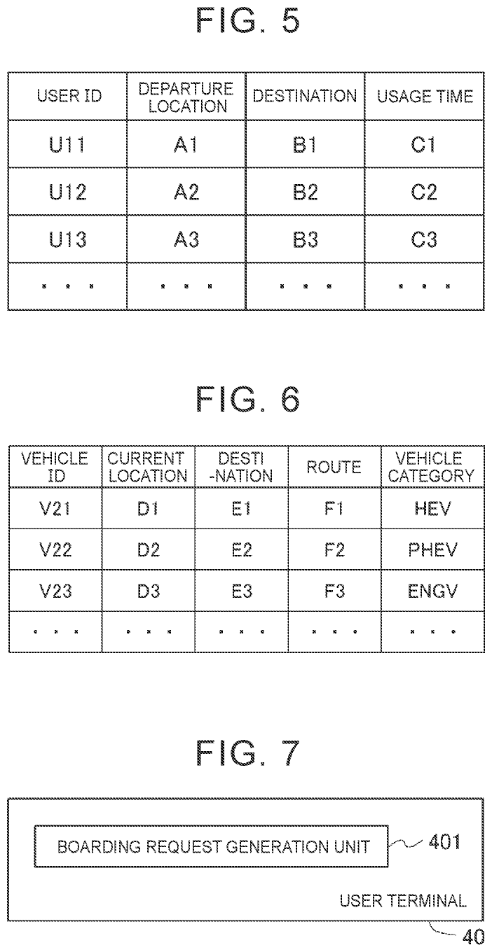

The user information DB 311 is provided by storing the user information in the auxiliary storage unit 33 described above. Here, the configuration of the user information stored in the user information DB 311 will be described based on FIG. 5. FIG. 5 is a diagram showing an example of a table configuration of the user information stored in the user information DB 311. The table of the information stored in the user information DB 311 includes fields for the user ID, the departure location, the destination, and the usage time. Identification information (user ID) for identifying the user is input in the user ID field. The user ID is assigned to each user by the boarding request acquisition unit 301. Information indicating the departure location of the user is input in the departure location field. Information indicating the destination of the user is input in the destination field. Information on the date and time when the user uses the vehicle 10 is input in the usage time field. These kinds of information are transmitted from the user terminal 40 to the server 30. In the departure location field, the position information transmitted from the user terminal 40 may be input. Further, the departure location and the destination may be indicated by, for example, latitude and longitude, or may be indicated by an address, the name of a building, or the like.

The vehicle information DB 312 is provided by storing information (vehicle information) on the movement of the vehicle 10 in the auxiliary storage unit 33. Here, the configuration of the vehicle information stored in the vehicle information DB 312 will be described based on FIG. 6. FIG. 6 is a diagram showing an example of a table configuration of the vehicle information stored in the vehicle information DB 312. The table of the vehicle information includes fields for the vehicle ID, the current location, the destination, the route, the predetermined area, and the vehicle category. Identification information (vehicle ID) for identifying the vehicle is input in the vehicle ID field. Information indicating the current location of the vehicle 10 is input in the current location field. Information indicating the final destination when the vehicle 10 moves is input in the destination field. When the vehicle 10 returns to the departure location, the departure location and the destination may be the same position. As another method, information on the destination of the user may be input in the destination field. In this case, the vehicle 10 that has arrived at the destination of the user may return to the departure location through the same route as the outbound route. The current location and the destination of the vehicle 10 are indicated by, for example, latitude and longitude. Information indicating the route of the vehicle 10 is input in the route field. A route corresponding to the combination determined by the vehicle dispatch unit 304 is input in the route field. The route is a route for the vehicle 10 to move to the destination stored in the destination field, and is a route generated by the route generation unit 303. Information that allows determining whether the route of each vehicle 10 passes through the predetermined area is input in the predetermined area field. Information on the category of the vehicle 10 according to the drive source of the vehicle 10 is input in the vehicle category field. Information that allows determining whether the vehicle 10 is the BEV, the PHEV, the HEV, or the internal combustion engine vehicle is input in the vehicle category field.

In the map information DB 313, as the map information, for example, link data related to a road (link), node data related to a node point, intersection data related to each intersection, search data for searching a route, facility data related to a facility, search data for searching a point, and the like are stored. Further, information on the speed limit, etc. corresponding to each road or information on the attributes of each road may be stored. Further, the map information stores information that allows determining the predetermined area.

Next, the function of the user terminal 40 will be described. FIG. 7 is a diagram illustrating a functional configuration of the user terminal 40. The user terminal 40 includes a boarding request generation unit 401 as a functional component. The processor 41 of the user terminal 40 executes the process of the boarding request generation unit 401 using a computer program stored in the main storage unit 42. However, a part of the process of the boarding request generation unit 401 may be executed by a hardware circuit.

The boarding request generation unit 401 outputs an operation screen to the display 45, for example, and generates a boarding request in response to an input by the user to the input unit 44 of the user terminal 40. The generated boarding request is transmitted to the server 30 by the boarding request generation unit 401. The boarding request includes the user information (for example, the departure location, the destination, and the usage time). The user inputs the user information via the input unit 44. The departure location is a point where the user wishes to board the vehicle. The destination is a point where the user wishes to get off the vehicle. The usage time is the date and time when the user wishes to board the vehicle. When the point where the vehicle 10 stops is determined in advance, the departure location and the destination may be selected from points where the vehicle 10 stops. Further, when the vehicle 10 is operated according to a timetable, the usage time may be selected according to the timetable. The boarding request generation unit 401 generates, for example, the boarding request according to the input from the user and transmits the boarding request to the server 30. The boarding request generation unit 401 may transmit the position information acquired by the position information sensor 47 to the server 30 as the departure location.

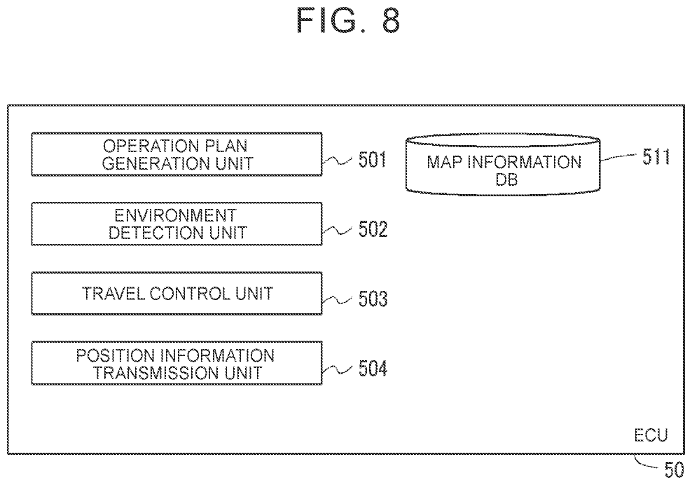

Next, the function of the ECU 50 of the vehicle 10 will be described. The vehicle 10 described below is an autonomous traveling vehicle. FIG. 8 is a diagram showing a functional configuration of the ECU 50. The ECU 50 includes an operation plan generation unit 501, an environment detection unit 502, a travel control unit 503, a position information transmission unit 504, and a map information DB 511 as functional components. The processor 11 of the ECU 50 executes the processes of the operation plan generation unit 501, the environment detection unit 502, the travel control unit 503, and the position information transmission unit 504 by a computer program stored in the main storage unit 12. However, any of the functional components or part of the processes thereof may be executed by a hardware circuit. Note that any of the functional components of the ECU 50 or part of the processes thereof may be executed by another computer connected to the network N1.

The map information DB 511 is established when the program of a DBMS executed by the processor 11 manages the data stored in the auxiliary storage unit 13. The map information DB 511 is, for example, a relational database. The map information DB 511 has the same function as the map information DB 313 of the server 30.

The operation plan generation unit 501 acquires the operation command from the server 30 and generates the operation plan of the vehicle 10. The operation command includes information on the route of the vehicle 10. The operation plan generation unit 501 calculates the route of the vehicle 10 based on the operation command provided by the server 30 and generates the operation plan for moving on the route.

The environment detection unit 502 detects the environment around the vehicle 10 that is necessary for autonomous traveling, based on the data acquired by the environment information sensor 16. Objects to be detected include, for example, the number and the positions of lanes, the number and the positions of other moving bodies around the vehicle 10, the number and the positions of obstacles around the vehicle 10 (pedestrians, bicycles, structures, buildings, etc.), the structure of the road, road signs, and the like, but not limited to these. Any object may be detected as long as it is necessary for autonomous traveling. For example, when the environment information sensor 16 is a stereo camera, image data taken thereby is subjected to image processing to detect the objects around the vehicle 10. Data on the surrounding environment of the vehicle 10 (hereinafter, environmental data) detected by the environment detection unit 502 is transmitted to the travel control unit 503 described below.

The travel control unit 503 generates a control command for controlling autonomous traveling of the vehicle 10, based on the operation plan generated by the operation plan generation unit 501, the environmental data generated by the environment detection unit 502, and the position information of the vehicle 10 that is acquired by the position information sensor 15. For example, the travel control unit 503 generates the control command to cause the vehicle 10 to travel on a predetermined route while suppressing obstacles from entering a predetermined safety area around the vehicle 10. The generated control command is transmitted to the electric motor 17, the internal combustion engine 19, or the like. A known method can be adopted as a method of generating the control command for causing the vehicle 10 to travel autonomously. Further, a known method can be also adopted as a method of controlling the BEV 10A, the PHEV 10B, the HEV 10C, and the internal combustion engine vehicle 10D.

Further, the travel control unit 503 generates the control command so that the vehicle 10 travels with the electric motor 17 within the predetermined area according to the operation command. At this time, in the PHEV 10B and the HEV 10C, the operation of the internal combustion engine 19 for electric power generation is also prohibited. Further, in the PHEV 10B and the HEV 10C, the travel control unit 503 determines whether the vehicle 10 is located within the predetermined area based on the position information detected by the position information sensor 15 and the information on the predetermined area stored in the map information DB 511, and when the vehicle 10 is located within the predetermined area, generates a control command so that the vehicle 10 travels with the electric motor 17. On the other hand, when the vehicle 10 is located outside the predetermined area, the travel control unit 503 generates a control command so that a drive source according to the travel condition is selected. The control command when the vehicle 10 is located outside the predetermined area may be the same as the conventional control command.

The position information transmission unit 504 transmits the position information acquired from the position information sensor 15 to the server 30 via the communication unit 14. The timing at which the position information transmission unit 504 transmits the position information can be set as appropriate, and for example, the position information may be transmitted periodically, may be transmitted in synchronization with the timing of transmitting some information to the server 30, or may be transmitted in response to a request from the server 30. The position information transmission unit 504 transmits the position information to the server 30 together with the vehicle ID.

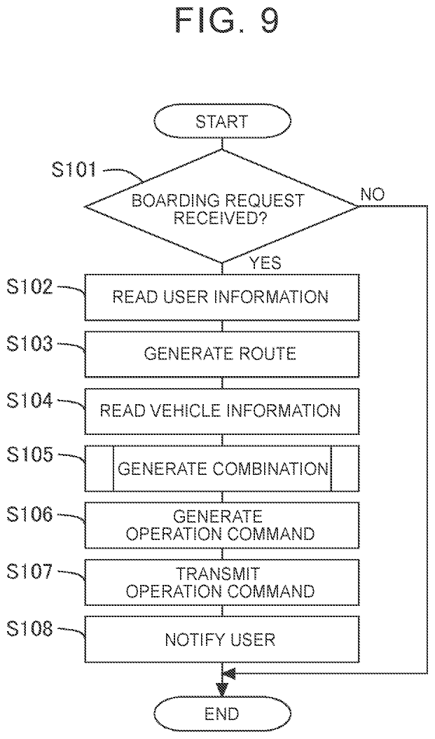

Next, a vehicle dispatch process in the server 30 will be described. FIG. 9 is a flowchart of the vehicle dispatch process according to the first embodiment. The vehicle dispatch process shown in FIG. 9 is executed at the server 30 at predetermined time intervals.

In step S101, the vehicle dispatch unit 304 determines whether a boarding request is received from the user terminal 40. The vehicle dispatch unit 304 determines whether there is a boarding request in which the vehicle 10 is not yet combined (that is, the vehicle 10 is not dispatched). When the determination result is Yes in step S101, the process proceeds to step S102, and when the determination result is No, the routine is terminated.

In step S102, the route generation unit 303 reads the user information from the user information DB 311. In step S103, the route generation unit 303 generates a route corresponding to each user based on the user information of each user. The route generation unit 303 generates, for example, a route such that the vehicle moves from the departure location of the user to the destination of the user in the shortest distance or the shortest time. The routes are generated for all users. The route may be generated on the premise that the same vehicle 10 is used by a plurality of users for rideshare.

In step S104, the vehicle dispatch unit 304 reads the vehicle information from the vehicle information DB 312. In step S105, the vehicle dispatch unit 304 generates a combination of each route generated in step S103 and the vehicle 10.

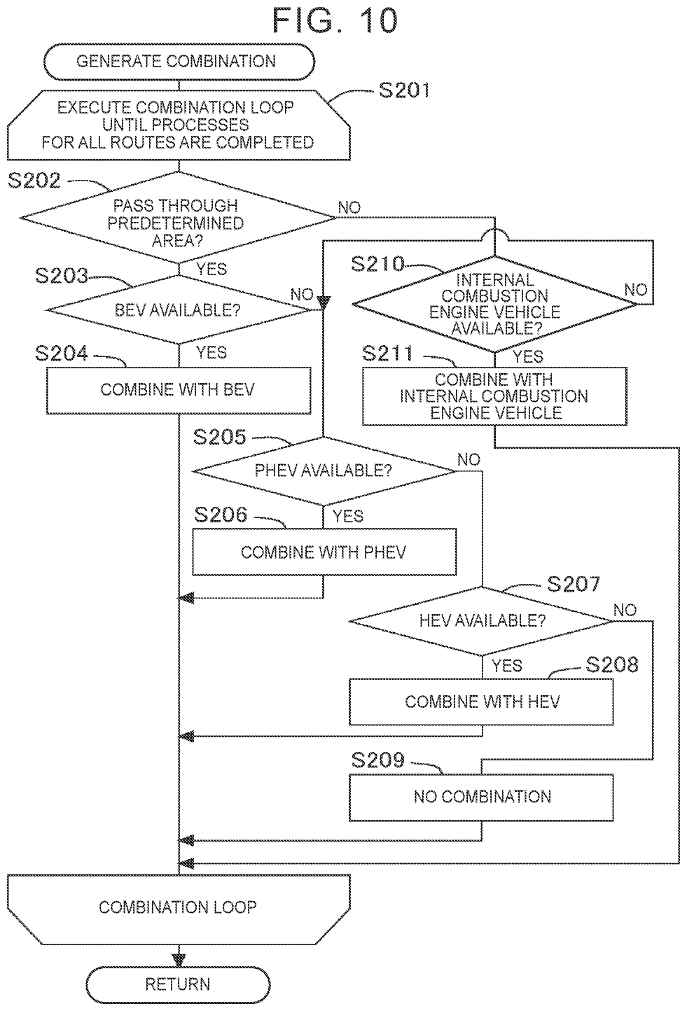

Here, FIG. 10 is a flowchart showing a flow of a process for generating a combination of a route and the vehicle 10 executed in step S105 of FIG. 9. In step S201, the vehicle dispatch unit 304 executes the combination loop. The combination loop is repeated until the processes for all the routes generated in step S103 are completed.

In step S202, the vehicle dispatch unit 304 determines whether a target route passes through the predetermined area. The vehicle dispatch unit 304 determines whether at least a part of the target route is located within the predetermined area from the coordinates of each point of the target route and the information on the predetermined area stored in the map information DB 313. When the determination result is Yes in step S202, the process proceeds to step S203, and when the determination result is No, the process proceeds to step S210.

In step S203, the vehicle dispatch unit 304 determines whether there is a vacancy in the BEV 10A. That is, in order to preferentially dispatch the BEV 10A when passing through the predetermined area, it is first determined whether there is a vacancy in the BEV 10A. When the determination result is Yes in step S203, the process proceeds to step S204, and when the determination result is No, the process proceeds to step S205. In step S204, the vehicle dispatch unit 304 combines the target route with the BEV 10A.

On the other hand, in step S205, the vehicle dispatch unit 304 determines whether there is a vacancy in the PHEV 10B. That is, in order to dispatch the PHEV 10B having the next highest priority after the BEV 10A, it is determined whether there is a vacancy in the PHEV 10B. When the determination result is Yes in step S205, the process proceeds to step S206, and when the determination result is No, the process proceeds to step S207. In step S206, the vehicle dispatch unit 304 combines the target route with the PHEV 10B.

In step S207, the vehicle dispatch unit 304 determines whether there is a vacancy in the HEV 10C. That is, when there is no vacancy in the PHEV 10B, it is determined whether there is a vacancy in the HEV 10C to dispatch the HEV 10C. When the determination result is Yes in step S207, the process proceeds to step S208, and when the determination result is No, the process proceeds to step S209. In step S208, the vehicle dispatch unit 304 combines the target route with the HEV 10C.

In step S209, the vehicle dispatch unit 304 determines that there is no vehicle 10 to be combined with the target route. That is, even though the target route is the first route that passes through the predetermined area, there is no vacancy in the vehicle 10 that can travel with the electric motor 17, and therefore the vehicle 10 cannot be combined with the target route. In this case, the process proceeds to the process of the next route without combining the vehicle 10.

On the other hand, in step S210, the vehicle dispatch unit 304 determines whether there is a vacancy in the internal combustion engine vehicle 10D. That is, since the target route is a route that does not pass through the predetermined area, there is no restriction on the drive source. In this case, any vehicle 10 can be combined, but the vehicle 10 that can travel with the electric motor 17 as a drive source is preferentially assigned to the first route passing through the predetermined area. Therefore, in step S210, it is determined whether it is possible to combine the internal combustion engine vehicle 10D that cannot pass through the predetermined area. When the determination result is Yes in step S210, the process proceeds to step S211, and when the determination result is No, the process proceeds to step S205. As another method, when the determination result is No in step S210, the process may proceed to step S203 or step S207. As still another method, when the determination result is No in step S210, it may be determined whether there is a vacancy in the HEV 10C, the PHEV 10B, and the BEV 10A in this order. That is, the route and the vehicle 10 may be combined with the priority reversed from the case of the first route that passes through the predetermined area.

In step S211, the vehicle dispatch unit 304 combines the target route with the internal combustion engine vehicle 10D. In this way, the combination of the route and the vehicle 10 is generated.

Returning to FIG. 9, in step S106, the vehicle dispatch unit 304 generates the operation command for each vehicle 10 such that each vehicle 10 travels on the corresponding route based on the generated combination. The operation command is generated for each vehicle 10. Information on the point at which the drive sources of the PHEV 10B and the HEV 10C are switched may be included in the operation command. For example, a command may be generated to forcibly switch the drive source to the electric motor 17 when the PHEV 10B and the HEV 10C enter the predetermined area from outside the predetermined area.

In step S107, the vehicle dispatch unit 304 transmits the operation command generated in step S106 to each vehicle 10. In each vehicle 10 that has received the operation command, an operation plan is generated according to the operation command. Then, in step S108, the vehicle dispatch unit 304 notifies the user terminal 40 of information on the vehicle 10. For example, information for notifying the user of the number, the color, the category, the feature, etc. of the vehicle 10 is transmitted. The user terminal 40 that has received this notification causes the display 45 to display the information on the vehicle 10. When it is determined in step S209 that there is no vehicle 10 to be combined, the user may be notified that the vehicle 10 cannot be arranged.

As described above, according to the first embodiment, the vehicle 10 that can travel with the electric motor 17 is preferentially dispatched to the predetermined area where only traveling with the electric motor 17 is allowed, and therefore an appropriate vehicle dispatch can be performed.

### Second Embodiment

In the first embodiment, when the vehicle 10 that travels in the predetermined area cannot be arranged, the user is notified that the vehicle 10 cannot be arranged and the vehicle 10 is not arranged. However, in a second embodiment, when the vehicle 10 that travels in the predetermined area cannot be arranged, a route detouring the predetermined area is generated, and for example, the internal combustion engine vehicle 10D is dispatched. Since the hardware is the same as that of the first embodiment, the description thereof will be omitted.

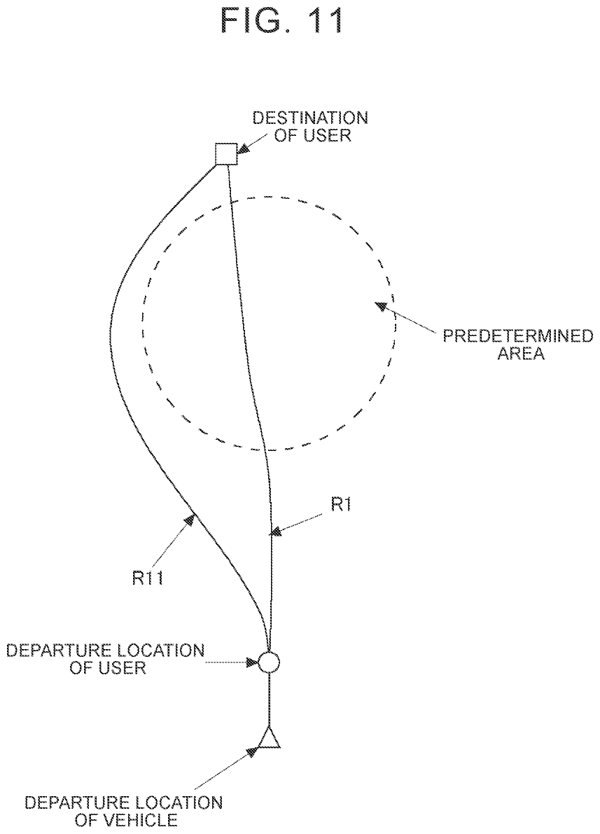

FIG. 11 is a diagram illustrating a detour route. R1 is the same route as R1 in FIG. 4. R1 is, for example, a route generated so that the travel distance is the shortest. On the other hand, R11 is a detour route whose route is changed so as not to pass through the predetermined area with respect to R1. In this way, when none of the departure location of the vehicle, the departure location of the user, and the destination of the user are located within the predetermined area, a detour route can be generated. In this case, the travel distance may increase compared to the route passing through the predetermined area, but the user can move to the destination.

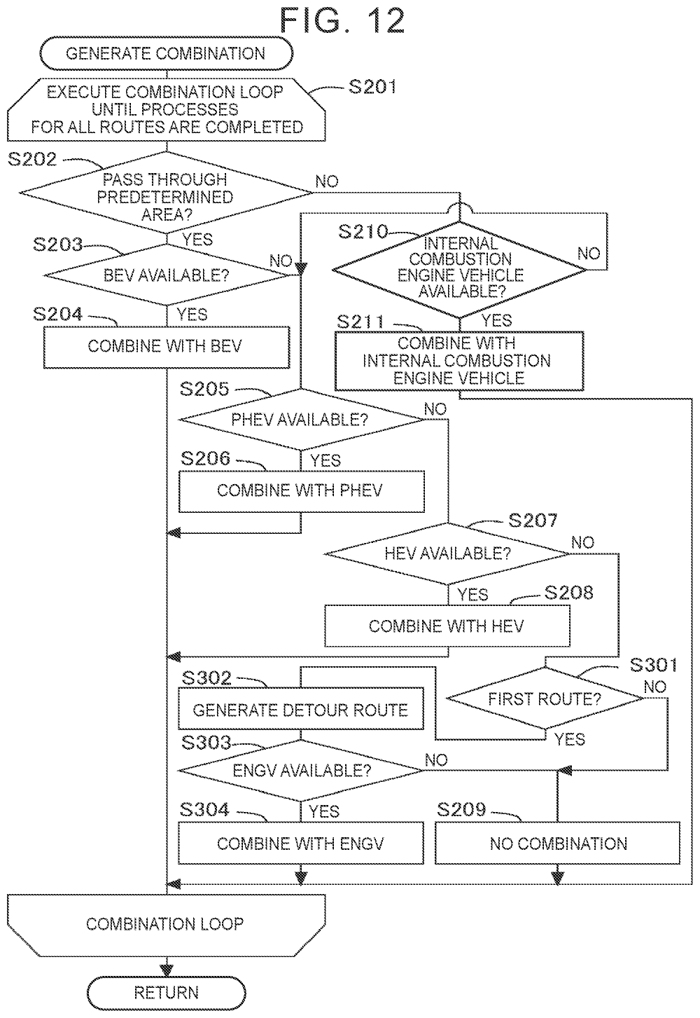

Here, FIG. 12 is a flowchart showing a flow of a process for generating a combination of a route and the vehicle 10 executed in step S105 of FIG. 9. The steps in which the same processes as those in the flow in FIG. 10 are executed are designated by the same reference signs, and the description thereof will be omitted. In the flowchart shown in FIG. 12, when the determination result is No in step S207, the process proceeds to step S301. In step S301, the vehicle dispatch unit 304 determines whether the target route is the first route. Here, after the determination result of No is made in step S210, it is not necessary to create a route detouring the predetermined area, and the vehicle 10 cannot be arranged, so the user is notified that the vehicle 10 cannot be arranged. When the determination result is Yes in step S301, the process proceeds to step S302, and when the determination result is No, the process proceeds to step S209.

In step S302, the route generation unit 303 generates a detour route based on the user information of the user corresponding to the target route. At this time, the route generation unit 303 generates a route detouring the predetermined area. Therefore, the newly generated detour route does not correspond to the first route. In step S302, the route generation unit 303 may not be able to generate a detour route. For example, when any of the departure location of the vehicle, the departure location of the user, and the destination of the user is located within the predetermined area, a detour route cannot be generated. In such a case, it is not necessary to generate a detour route.

In step S303, the vehicle dispatch unit 304 determines whether there is a vacancy in the internal combustion engine vehicle 10D. That is, since the new target route is a route that does not pass through a predetermined area, in step S303, it is determined whether the internal combustion engine vehicle 10D can be combined. When the new route cannot be generated in step S302, the determination result is No in step S303. When the determination result is Yes in step S303, the process proceeds to step S304, and when the determination result is No, the process proceeds to step S209.

In step S304, the vehicle dispatch unit 304 combines the target route with the internal combustion engine vehicle 10D. In this way, the combination of the route and the vehicle 10 is generated.

As described above, according to the second embodiment, when the vehicle 10 that can pass through the predetermined area does not exist, a route detouring the predetermined area is generated and a combination of the route and the vehicle 10 is generated. This can suppress the user from being unable to move.

An incentive may be provided to the user who moves using the vehicle 10 that travels on the detour route. This makes it possible to eliminate the disadvantage when the user rides on the vehicle 10 that travels on the detour route. The incentive may be, for example, a discount on the usage fee of the vehicle 10. Further, the incentive may be provided by preferentially assigning the vehicle 10 with a reduced boarding time when the same user uses the vehicle 10 from the next time onward. Information on the incentive is generated, for example, by the vehicle dispatch unit 304 in step S304, and is transmitted to the user terminal 40 together with a notification to the user in step S108.

### Third Embodiment

The vehicle 10 that passes through the predetermined area needs to store the electric power corresponding to the electric power in the battery 18 in advance in order to drive the electric motor 17 when passing through the predetermined area. In the first embodiment, the vehicle 10 and the route are combined regardless of the charge state of the battery 18, but when the vehicle 10 having a small charge amount of the battery 18 is combined with the first route, there is a risk of electric power shortage while the vehicle 10 is passing through the predetermined area.

Therefore, in the third embodiment, the vehicle is dispatched including the charge control of the battery 18. For example, when the PHEV 10B or the HEV 10C travels on a route including traveling outside the predetermined area for 20 km and traveling within the predetermined area for 20 km, an operation command is generated so that the vehicle 10 travels in the HEV mode using the electric motor 17 or the internal combustion engine 19 for traveling outside the predetermined area, and the vehicle 10 travels in the BEV mode using only the electric motor 17 for traveling within the predetermined area. At this time, assuming that, for example, 10% of the total capacity of the battery 18 is consumed outside the predetermined area, and, for example, 30% of the total capacity of the battery 18 is consumed within the predetermined area, a charge plan is generated so that the battery 18 is charged to 10+30=40% or more of the total capacity before departure of the vehicle 10.

The combination of the route and the vehicle 10 is determined in the same manner as in the first embodiment. Therefore, in the third embodiment, a charge plan is subsequently generated so that each vehicle 10 is charged.

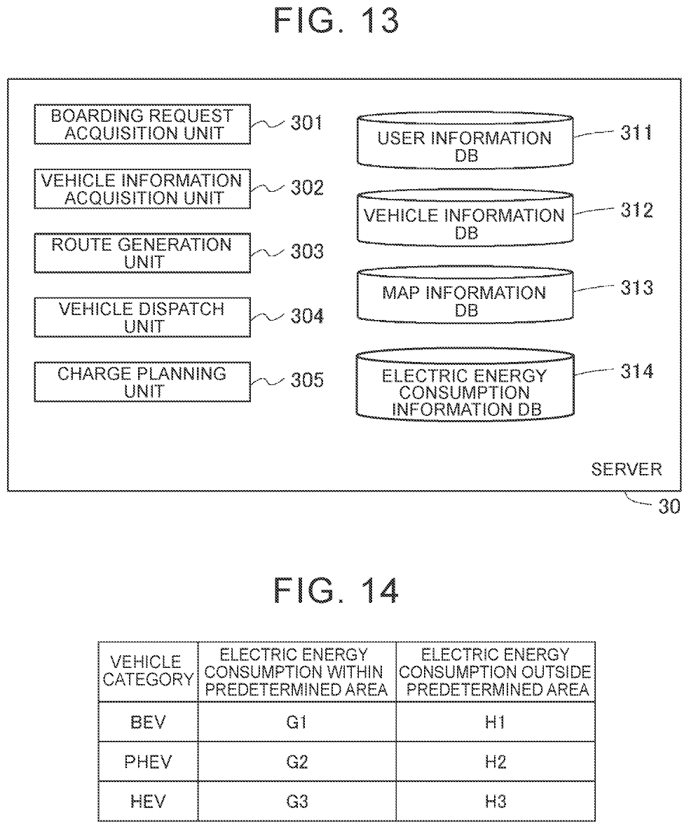

FIG. 13 is a diagram showing an example of a functional configuration of the server 30 according to the third embodiment. The server 30 includes, as functional components, the boarding request acquisition unit 301, the vehicle information acquisition unit 302, the route generation unit 303, the vehicle dispatch unit 304, a charge planning unit 305, the user information DB 311, the vehicle information DB 312, the map information DB 313, and an electric energy consumption information DB 314. Since the configurations other than the charge planning unit 305 and the electric energy consumption information DB 314 are the same as those in the first embodiment, the description thereof will be omitted. In the third embodiment, the charge planning unit 305 and the electric energy consumption information DB 314 will be mainly described.

The processor 31 of the server 30 executes the process of the charge planning unit 305 using a computer program stored in the main storage unit 32. However, a part of the process thereof may be executed by a hardware circuit.

The electric energy consumption information DB 314 is established when the program of a DBMS executed by the processor 31 manages the data stored in the auxiliary storage unit 33. The electric energy consumption information DB 314 is, for example, a relational database.

FIG. 14 is a diagram showing an example of a table configuration of electric energy consumption information stored in the electric energy consumption information DB 314. The table of information stored in the electric energy consumption information DB 314 includes fields for the vehicle category, electric energy consumption within the predetermined area, and electric energy consumption outside the predetermined area. Information on the category of the vehicle 10 according to the drive source of the vehicle 10 is input in the vehicle category field. Information that allows determining whether the vehicle 10 is the BEV, the PHEV, or the HEV is input in the vehicle category field. Information on the electric energy consumption per unit distance when traveling within the predetermined area corresponding to each vehicle category is input in the electric energy consumption field within the predetermined area. Further, information on the electric energy consumption per unit distance when traveling outside the predetermined area corresponding to each vehicle category is input in the electric energy consumption field outside the predetermined area.

The electric energy consumption within the predetermined area and the electric energy consumption outside the predetermined area are, for example, the electric energy consumed per unit distance when each vehicle 10 travels assuming that the vehicle 10 travels under a predetermined travel condition (may be a predetermined speed and a predetermined load). The predetermined travel condition may be an average travel condition. The electric energy may be calculated based on past data, for example. In the BEV 10A, the electric energy consumption within the predetermined area and the electric energy consumption outside the predetermined area may be the same.

Further, the electric energy consumption within the predetermined area for the PHEV 10B and the HEV 10C may be an average value of the electric energy consumption per unit distance when traveling only with the electric motor 17. On the other hand, the electric energy consumption outside the predetermined area for the PHEV 10B and the HEV 10C may be an average value of the electric energy consumption per unit distance when the electric motor 17 and the internal combustion engine 19 are switched on average. For switching between the electric motor 17 and the internal combustion engine 19, for example, past data is used.

The charge planning unit 305 calculates the travel distance within the predetermined area and the travel distance outside the predetermined area for each route based on the information on the distance stored in the map information DB 313. Then, based on the category of the vehicle 10 combined with each route and the information stored in the electric energy consumption information DB 314, the travel distance within the predetermined area is multiplied by the electric energy consumption within the predetermined area to calculate the electric energy required to travel within the predetermined area. Similarly, the travel distance outside the predetermined area is multiplied by the electric energy consumption outside the predetermined area to calculate the electric energy required to travel outside the predetermined area. Subsequently, the command for each vehicle 10 is generated so that the battery 18 is charged with an electric energy equal to or more than the sum of the electric energy required to travel within the predetermined area and the electric energy required to travel outside the predetermined area.

In the above description, the electric energy required for each route is calculated based on the average electric energy consumption, but the present disclosure is not limited to this, and the electric energy consumption may be calculated in detail. For example, the electric energy consumption per unit distance when each vehicle 10 travels on each route may be calculated assuming that the vehicle 10 travels under a predetermined travel condition (may be a predetermined speed and a predetermined load). The predetermined travel condition may be set according to the speed limit of each road on the route, or may be set according to the data when the vehicle traveled on the same road in the past. In this case, it may be assumed that the vehicle 10 is constantly driven at the speed limit of the road. Further, a predetermined speed may be set according to the attributes of the road (for example, a highway, a main road, a residential area, a speed limit, an uphill, a downhill, etc.). When the attributes of the road change partway through the route, the electric energy consumption per unit distance for each road may be calculated based on the travel condition for each attribute of the road.

Further, for the PHEV 10B and the HEV 10C that travel outside the predetermined area, the electric energy consumption per unit distance may be calculated assuming that the internal combustion engine 19 operates according to the travel condition, for example. For example, with the data of the travel condition for each road acquired and stored in the auxiliary storage unit 33, the electric energy consumption per unit distance may be calculated assuming that the internal combustion engine 19 operates according to the travel condition. As the data of the travel condition, the data of another vehicle 10 that has traveled on the same road in the past may be accumulated, and for example, an average value may be obtained and used. Further, the travel condition may be estimated from the speed limit or the like of each road. In this case, it may be assumed that the vehicle 10 is constantly driven at the speed limit of the road. Further, it may be considered that the internal combustion engine 19 is operated on a highway, for example.

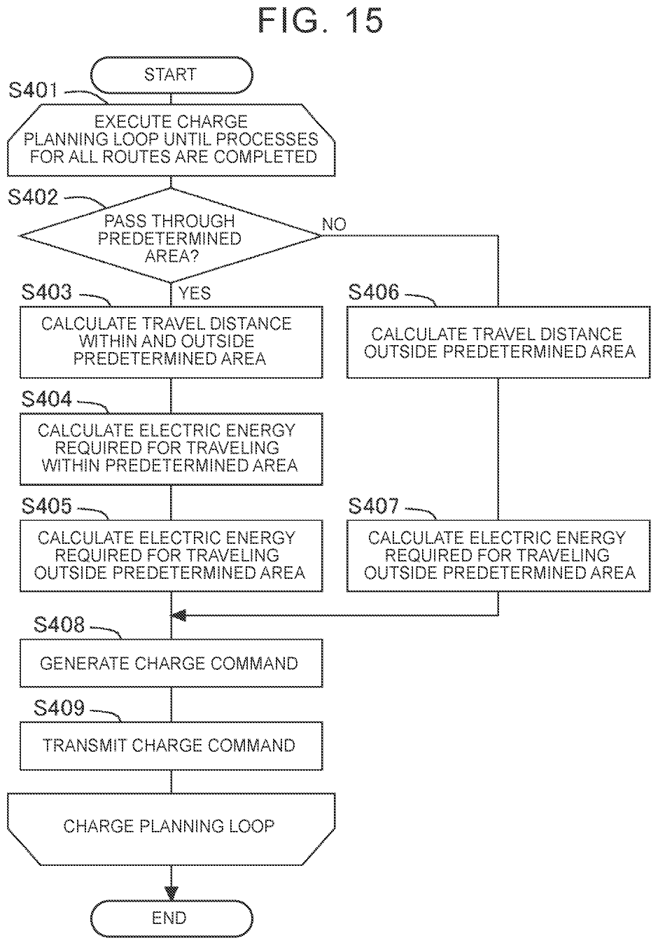

Next, the charge plan generation process in the server 30 will be described. FIG. 15 is a flowchart of a charge plan generation process according to the third embodiment. The processes shown in FIG. 15 are executed in the server 30 after the routine shown in FIG. 9 is completed.

In step S401, the charge planning unit 305 executes the charge planning loop. The charge planning loop is repeated until the processes for all the routes generated in step S103 in FIG. 9 are completed. In step S402, the charge planning unit 305 determines whether a target route passes through the predetermined area. In step S402, the same process as in step S202 is executed. When the determination result is Yes in step S402, the process proceeds to step S403, and when the determination result is No, the process proceeds to step S406.

In step S403, the charge planning unit 305 calculates the travel distance within the predetermined area and outside the predetermined area for the target route. The charge planning unit 305 calculates each of the travel distance within the predetermined area and the travel distance outside the predetermined area for the target route based on the information on the distance stored in the map information DB 313.

In step S404, the charge planning unit 305 calculates the electric energy required for traveling within the predetermined area. The charge planning unit 305 acquires the electric energy consumption within the predetermined area stored in the electric energy consumption information DB 314 based on the vehicle category corresponding to the target route, and calculates the electric energy required for traveling within the predetermined area by multiplying the acquired electric energy consumption within the predetermined area by the travel distance within the predetermined area calculated in step S403.

In step S405, the charge planning unit 305 calculates the electric energy required for traveling outside the predetermined area. The charge planning unit 305 acquires the electric energy consumption outside the predetermined area stored in the electric energy consumption information DB 314 based on the vehicle category corresponding to the target route, and calculates the electric energy required for traveling outside the predetermined area by multiplying the acquired electric energy consumption outside the predetermined area by the travel distance outside the predetermined area calculated in step S403.

Further, in step S406, the charge planning unit 305 calculates the travel distance outside the predetermined area for the target route. The charge planning unit 305 calculates the travel distance outside the predetermined area for the target route based on the information on the distance stored in the map information DB 313.

Further, in step S407, the charge planning unit 305 calculates the electric energy required for traveling outside the predetermined area. The charge planning unit 305 acquires the electric energy consumption outside the predetermined area stored in the electric energy consumption information DB 314 based on the vehicle category corresponding to the target route, and calculates the electric energy required for traveling outside the predetermined area by multiplying the acquired electric energy consumption outside the predetermined area by the travel distance outside the predetermined area calculated in step S406. When the vehicle 10 that travels on the target route is the internal combustion engine vehicle 10D, the electric energy required for traveling outside the predetermined area is zero.

In step S408, the charge planning unit 305 generates a charge command. The charge command is information for transmitting a command on charging to the vehicle 10. The charge planning unit 305 generates a charge command to charge the battery 18 with the electric energy equal to or more than the sum of the electric energy required for traveling outside the predetermined area and the electric energy required for traveling within the predetermined area. Then, in step S409, the charge planning unit 305 transmits the generated charge command to the corresponding vehicle 10.

As described above, according to the present embodiment, the vehicle 10 is charged with the electric power required for traveling in the predetermined area in advance when the vehicle travels in the predetermined area, which can suppress the electric power from being insufficient within the predetermined area.

### Other Embodiments

The above-described embodiments are merely examples, and the present disclosure may be appropriately modified and implemented without departing from the scope thereof.

The processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function. For example, the server 30 may have a part of the functions of the vehicle 10. Further, for example, the vehicle 10 may have a part or all of the functions of the server 30.

Although the vehicle 10 has been described as an autonomous traveling vehicle in the above embodiments, a vehicle manually driven by the driver can be similarly applied. In this case, the vehicle 10 may display the route received from the server 30 on the display of the vehicle 10, for example, to guide the user. Further, the user terminal 40 may receive a route from the server 30 and display the route on the display 45 of the user terminal 40 to guide the user.

The present disclosure can also be implemented by supplying a computer with a computer program that implements the functions described in the above embodiments, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, HDD, etc.) and an optical disc (compact disc read-only memory (CD-ROM), digital versatile disc (DVD), Blu-ray disc, etc.), a ROM, a RAM, an EPROM, an electrically erasable programmable read only memory (EEPROM), a magnetic card, a flash memory, an optical card, and any type of medium suitable for storing electronic commands.

What is claimed is:

1. An information processing device including a control unit that executes generation of an operation command for a plurality of vehicles of different categories, including a vehicle that is able to travel with an electric motor, based on information on a predetermined area that is an area where only the vehicle that is able to travel with the electric motor is allowed to pass through.

2. The information processing device according to claim 1, wherein the vehicles include a vehicle including the electric motor as a drive source and a vehicle including an internal combustion engine as a drive source.

3. The information processing device according to claim 1, wherein the operation command includes information on selection of a drive source for each of the vehicles.

4. The information processing device according to claim 1, wherein the control unit executes:
determining a combination of a plurality of routes and the vehicles; and
generating the operation command for each of the vehicles based on the determined combination of the routes and the vehicles.

5. The information processing device according to claim 4, wherein the control unit determines the combination of the routes and the vehicles such that a route passing through the predetermined area among the routes is combined with the vehicle that is able to travel with the electric motor among the vehicles.

6. The information processing device according to claim 5, wherein:
the vehicles include a battery electric vehicle including only the electric motor as a drive source and a hybrid electric vehicle including the electric motor and an internal combustion engine as drive sources; and
the control unit preferentially combines the battery electric vehicle with the route passing through the predetermined area over the hybrid electric vehicle.

7. The information processing device according to claim 1, wherein the generation of the operation command includes generation of a route detouring the predetermined area.

8. The information processing device according to claim 7, wherein when there is no vehicle that is able to be combined with the route passing through the predetermined area among the vehicles, the control unit generates the route detouring the predetermined area and combines the route detouring the predetermined area with a vehicle that is unable to travel in the predetermined area with the electric motor.

9. The information processing device according to claim 7, wherein the control unit provides an incentive to a user who rides on a vehicle that travels on the route detouring the predetermined area.

10. The information processing device according to claim 1, wherein the operation command includes a charge plan for a battery that supplies electric power to the electric motor.

11. The information processing device according to claim 10, wherein the control unit generates the charge plan for each of the vehicles based on electric energy required when the vehicles travel within the predetermined area and electric energy required when the vehicles travel outside the predetermined area.

12. The information processing device according to claim 1, comprising a storage unit for storing information on the predetermined area and map information.

13. An information processing method wherein a computer executes:
receiving information on a predetermined area that is an area where only a vehicle that is able to travel with an electric motor is allowed to pass through; and
generating an operation command for a plurality of vehicles of different categories, including the vehicle that is able to travel with the electric motor, based on the information on the predetermined area.

14. The information processing method according to claim 13, wherein the vehicles include a vehicle including the electric motor as a drive source and a vehicle including an internal combustion engine as a drive source.

15. The information processing method according to claim 13, wherein the operation command includes information on selection of a drive source for each of the vehicles.

16. The information processing method according to claim 13, wherein the computer executes:
determining a combination of a plurality of routes and the vehicles; and
generating the operation command for each of the vehicles based on the determined combination of the routes and the vehicles.

17. The information processing method according to claim 16, wherein the computer determines the combination of the routes and the vehicles such that a route passing through the predetermined area among the routes is combined with the vehicle that is able to travel with the electric motor among the vehicles.

18. The information processing method according to claim 17, wherein:
the vehicles include a battery electric vehicle including only the electric motor as a drive source and a hybrid electric vehicle including the electric motor and an internal combustion engine as drive sources; and
the computer preferentially combines the battery electric vehicle with the route passing through the predetermined area over the hybrid electric vehicle.

19. The information processing method according to claim 13, wherein when there is no vehicle that is able to be combined with the route passing through the predetermined area among the vehicles, the computer generates a route detouring the predetermined area and combines the route detouring the predetermined area with a vehicle that is unable to travel in the predetermined area with the electric motor.

20. The information processing method according to claim 13, wherein:
the operation command includes a charge plan for a battery that supplies electric power to the electric motor; and
the computer generates the charge plan based on electric energy required when the vehicles travel within the predetermined area and electric energy required when the vehicles travel outside the predetermined area.
